(19) United States
(12) Patent Application Publication
(10) Pub. No.: US 2014/0025483 A1
(43) Pub. Date: Jan. 23, 2014

(54) SYSTEM AND METHOD FOR PROTECTING CONSUMER PRIVACY IN THE MEASURING OF THE EFFECTIVENESS OF ADVERTISEMENTS

(71) Applicants: Curtis Villars, Chatham, NJ (US); Todd Lowenberg, Redding, CT (US)

(72) Inventors: Curtis Villars, Chatham, NJ (US); Todd Lowenberg, Redding, CT (US)

(73) Assignee: MasterCard International Incorporated, Purchase, NY (US)

(21) Appl. No.: 13/554,402

(22) Filed: Jul. 20, 2012

(51) Int. Cl. G06Q 30/02

(52) U.S. Cl. 705/14.45

(57) ABSTRACT

A method for measuring the effectiveness of an advertisement includes: storing, in a database, a plurality of consumer data entries, each being associated with a consumer and wherein each includes at least a plurality of characteristics and activity data; identifying a subset of the plurality of characteristics; encrypting, by a processor the subset of characteristics for each consumer data entry using a one-way encryption; transmitting, by a transmitter, the one-way encryption; receiving, by a receiver, advertising data entries, each being associated with a consumer and wherein each includes at least the encrypted subset of characteristics and a segment indicator; identifying a subset of consumer data entries that correspond to the advertising data entries based on the encrypted subset of characteristics; and analyzing the activity data for each consumer data entry in the subset to measure the effectiveness of an advertisement based on the corresponding segment indicators.

### FIELD

The present disclosure relates to technical solutions for protecting consumer privacy in the measuring of the effectiveness of advertisements, specifically by measuring the effectiveness of an advertisement as to differentiated segments of consumers on the individual level using technology enabling protection of privacy and security of the individual consumers.

### BACKGROUND

In the ever expanding information age, merchants and advertisers have a desire to develop more effective and efficient advertising, which in turn requires some measure of the effectiveness of the advertising. Traditionally, methods and systems for measuring effectiveness of advertising have lacked in detail and efficiency. Analysis of overall revenue and consumer activity for a particular merchant may indicate that an advertisement campaign is effective, but the merchant is unable to deduce if it is the advertisement itself that resulted in the increased activity, or due to some other circumstance. In addition, this type of high level analysis is unable to provide specific information regarding advertising effectiveness, such as its effectiveness on particular demographic groups and its level of effectiveness, information which could be beneficial to not only the merchant, but to the end consumer as well.

Some present methods for measuring advertising effectiveness include surveying and polling consumers, on a website, or, with permission, tracking their activity on the worldwide web or the like. This type of analysis has several shortcomings not the least of which is the capture of Personally Identifiable Information (PII), the need for which is avoided in the presently disclosed system. Additionally, surveys and polls require consumers to volunteer information, which may be inaccurate or fabricated, and may be influenced as to whether the survey or poll is anonymous. The results of the analysis may be full of uncertainty at whether or not each consumer was in fact exposed to the advertisement or belongs to a particular segment that is differentiated from another segment in some fashion (exposed vs. not exposed, different demographics, manner and/or timing of delivery of the advertisement, differences in details of the advertisement, or nearly any differentiator that might be relevant to the advertiser or analyst), and whether or not the consumer's spending behavior was affected by the advertisement. In addition, surveys or polls take time and require consumer participation, which may result in a small and/or non-representative (self-selected) sample of all consumers for a given subject. Further, increased consumer concerns for privacy and security of personal information may result in even less participation and/or more unreliable information, and often require some form of consideration. Other methods for measuring advertising effectiveness include using collected data for groups of consumers and applying it to other, similar consumers known to have been exposed or unexposed to an advertisement. These types of methods use generalizations and group consumers together, which can result in less accurate and non-representative results as to the known consumers. Such lack of accuracy and representation may be greatly compounded when acting as a sample applied to all consumers. Many of these problems are due to technical issues in handling information about individuals, insofar as once information is associated with a particular person, there is a possibility or at least consumer perception that even after the data is aggregated or otherwise anonymized, the raw data can be derived or de-anonymized.

Thus, there is a need for a technical solution to provide greater assurance that the P11 is not used, tracked or captured. Also, there is a perceived opportunity for a technological solution to improve the measuring of advertising effectiveness by analyzing financial transaction information for individual consumers that are in a differentiated segments with respect to an advertisement, while still maintaining the privacy and security of the individual and consumer information.

### SUMMARY

The present disclosure provides a description of a system and method for protecting the privacy of consumers while measuring the effectiveness of an advertisement.

By way of non-limiting, high level description of the process detailed below, one entity (e.g., credit card processor) in possession of transaction information of individuals identified by a unique reference (e.g., a PAN such as a credit card number or simple record locator reference) that does not want to possess Personally Identifiable Information (PII) and receive from a demographic reporting agency that has the same unique identifier of individuals, geo-demo information about individuals together with one way encrypted PANs of the individuals. One-way means that once encrypted, it cannot be decrypted by the same party, e.g., a hash function. The result is an arbitrary reference that is not decipherable to determine the original data. This means that the entity is not getting PII.

The geo-demo information is then sorted until a subset of individual records has relatively unique members in the group (e.g., a percentage of individual records have completely unique geo-demo data). The geo-demo information that is used might be selected to include geo-demo data that an advertiser might have. The subset of individual records is then individually one-way encrypted, and the unencrypted geo-demo data is no longer in the entity's possession or control. That is, it is simply an arbitrary reference. The demographic reporting agency then sends of the encrypted unique reference numbers match with the unencrypted reference numbers, but because the geo-demo data is one-way encrypted, it is not PII even after being associated with the actual, unencrypted unique identifier or PAN.

The same one-way encryption is used by an advertiser to encrypt its geo-demo data of individuals who were in one segment (e.g., exposed to an advertisement, exposed to advertisement A, etc.) and individuals who are in another segment (e.g., were not exposed to the advertisement, exposed to advertisement B, etc.). The encrypted data files for individuals are unique enough because of the selection process to be matched using the encrypted geo-demo data from the advertiser. That is the encrypted geo-demo data acts as the key to match data files, neither of which are considered as having PII. The transaction data of the individuals who are members in one or the other of the two segments are observed and analyzed to determine difference is purchasing behavior between the two segments to determine advertising effectiveness, without the entity possessing PII, and without needing to identify spending behavior of individuals to either the merchant or the demographic reporting agency.

In this way, a technical solution is provided by directly measuring the actual effectiveness of advertising on individuals in a population, while assuring a higher level of privacy for the individuals. At a very high level, the present method and apparatus takes data from various sources that have overlapping data points and relate them in a sequence with encryption selectively interjected therein to prevent at least one party from being on possession of enough information for a particular purpose (e.g., to personally identify an individual). That is, at least one of the entities can avoid possessing enough information to be regarded as PII in the exemplary embodiment.

In more technical terms, an exemplary method for measuring the effectiveness of an advertisement may include: storing, in a database, a plurality of consumer data entries, each consumer data entry being associated with a consumer and wherein each consumer data entry includes at least a plurality of characteristics and activity data; identifying a subset of the plurality of characteristics; encrypting, by a processing device, the subset of the plurality of characteristics for each consumer data entry using a one-way encryption; transmitting, by a transmitting device, the one-way encryption; receiving, by a receiving device, advertising data entries, each advertising data entry being associated with a consumer and wherein each advertising data entry includes at least the encrypted subset of the plurality of characteristics and a segment indicator; identifying, in the database, a subset of consumer data entries that correspond to the advertising data entries based on the encrypted subset of the plurality of characteristics; and analyzing, by the processing device, the activity data for each consumer data entry in the subset of consumer data entries to measure the effectiveness of an advertisement based on the corresponding segment indicators.

A system for measuring the effectiveness for an advertisement may include a database, a processor, and a receiver. The database may be configured to store a plurality of consumer data entries, each consumer data entry being associated with a consumer and wherein each consumer data entry includes at least a plurality of characteristics and activity data. The processor may be configured to identify a subset of the plurality of characteristics, encrypt the subset of the plurality of characteristics for each consumer data entry using a one-way encryption, and transmit the one-way encryption. The receiver may be configured to receive advertising data entries, each advertising data entry being associated with a consumer and wherein each advertising data entry includes at least the encrypted subset of the plurality of characteristics and a segment indicator. The processor may be further configured to identify, in the database, a subset of consumer data entries that correspond to the advertising data entries based on the encrypted subset of the plurality of characteristics, and analyze the activity data for each consumer data entry in the subset of consumer data entries to measure the effectiveness of an advertisement based on the corresponding segment indicators.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for measuring the effectiveness of an advertisement in accordance with exemplary embodiments.

FIG. 2 is a flow chart illustrating the collecting of data while maintaining individual privacy and security in accordance with exemplary embodiments.

FIG. 3 is a block diagram illustrating an exemplary encrypted data set in accordance with exemplary embodiments.

FIG. 4 is a block diagram illustrating a processing server in accordance with exemplary embodiments.

FIG. 5 is a diagram illustrating the matching of encrypted individual consumer data to consumer exposure data in accordance with exemplary embodiments.

FIGS. 6A and 6B are a flow diagram illustrating a measurement solution for determining the effectiveness of an advertisement in accordance with exemplary embodiments.

FIG. 7 is a block diagram illustrating an exemplary computer system for use in the system of FIG. 1 in accordance with exemplary embodiments.

FIG. 8 is a flow chart illustrating an exemplary method for measuring the effectiveness of an advertisement in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Measuring Advertising Effectiveness

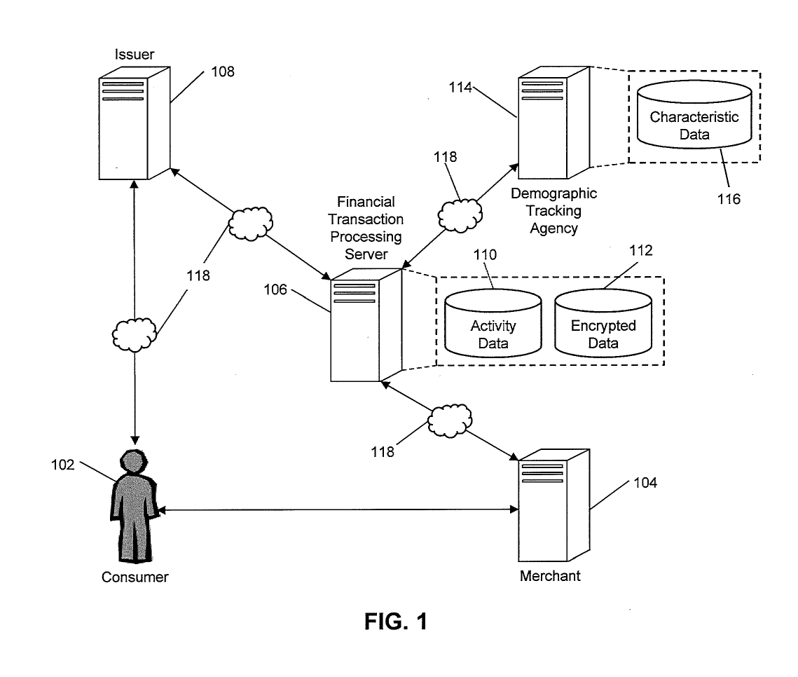

FIG. 1 illustrates a system 100 for measuring the effectiveness of an advertisement. The system 100 may include a merchant 104. The merchant 104 may be a retailer with a physical location, an online retailer, or any type of merchant or business (e.g., an advertising or survey service provider, manufacturer or supplier) wanting a measure of the effectiveness of an advertisement. The merchant 104 may run an advertisement, which may be advertised in a different manner to different consumers. For example, the advertisement may be exposed to some consumers and deliberately not exposed to other consumers, a first advertisement may be exposed to some consumers while a second advertisement may be exposed to others, etc.

The merchant 104 may conduct a transaction with a consumer 102. In an exemplary embodiment, the consumer 102 may use a payment card to pay for the transaction, such as with a payment card issued by an issuer 108. The payment card may be a credit card, debit card, hybrid card, merchant card or any other form of payment card that is processed by a financial transaction processing server 106.

The transaction between the merchant 104 and the consumer 102 may be processed by a financial transaction processing server 106, which may be part of the issuer 108 (e.g., American Express® or merchant cards or the like) or an agency that acts for, or on behalf of, the issuer 108 and the merchant 104 (e.g., or an acquirer such as an acquiring bank operating on behalf of the merchant 104), such as MasterCard®, VISA® or PayPal®, but nearly any financial transaction processor would be appropriate. Here, server means a discrete server, or a server farm, whether co-located or distributed.

The financial transaction processing server 106 may process the financial transaction. Methods for processing financial transactions will be apparent to persons having skill in the relevant art. The financial transaction processing server 106 may store (e.g., with the permission of the consumer 102) transaction data for the financial transaction in an activity data database 110, discussed in more detail below.

A demographic tracking agency 114, which is separate from the financial transaction processing server 106, may store characteristic data in a characteristic data database 116. In one embodiment, the characteristic data database 116 of the demographic tracking agency 114 may include personally identifiable information, discussed in more detail below. It may not, but the transaction data and the demographic data shares one or more data points (e.g., a PAN or arbitrary reference number). The financial transaction processing server 106 may obtain the characteristic data from the demographic tracking agency 114, but with all personally identifiable information removed or one-way encrypted, and store the encrypted data in an encrypted data database 112 such that it is not received in a usable form from the financial transaction processing server 106. The financial transaction processing server 106 may use the encrypted data and the activity data in order to measure the effectiveness of an advertisement, as discussed in more detail below.

The consumer 102, the merchant 104, the financial transaction processing agency 108, and the demographic tracking agency 114 (e.g., Nielsen®, Experian®, Equifax®, ComScore®, etc.) may each be configured to communicate via a network 118. The network 118 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

### Protecting Consumer Privacy in Dataset Creation

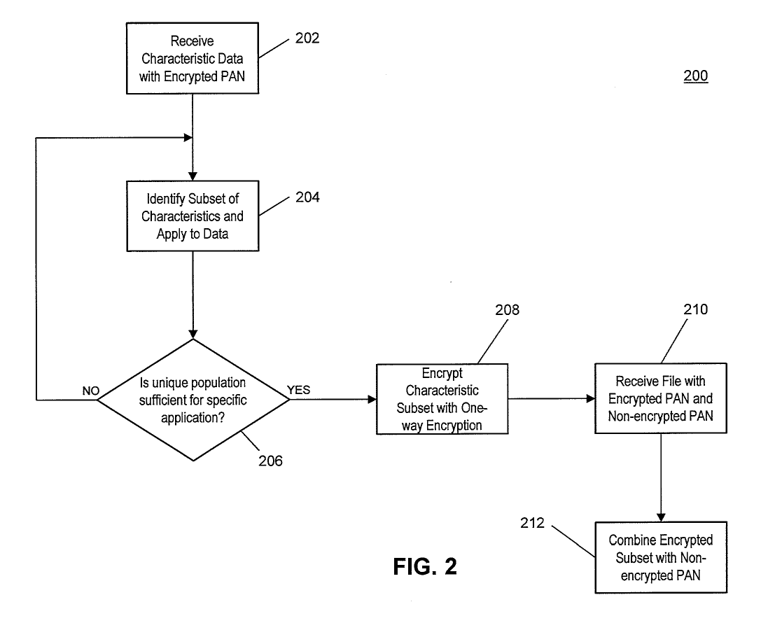

FIG. 2 illustrates a method 200 for creating an encrypted data dataset, discussed in more detail below, for storage in the encrypted data database 112. In an exemplary embodiment, the encrypted data database does not include any personally identifiable information.

In step 202, the financial transaction processing server 106 may receive characteristic data (e.g., from the demographic tracking agency 114 and stored in the characteristic data database 116) with an encrypted personal account number (PAN). The PAN may be a unique number associated with a consumer. In an exemplary embodiment, the PAN by itself is not personally identifiable. Characteristic data may be any type of data suitable associated with a consumer, such as geographic data, demographic data, or a combination thereof (e.g., geo-demo data). In one embodiment, the demographic tracking agency 114 may be in possession of personally identifiable information, such as a PAN for a consumer associated with characteristic data also corresponding to the consumer. The PAN may be encrypted (e.g., using a one-way encryption) by the demographic tracking agency 114 prior to being transmitted to the financial transaction processing server 106 such that the transmitted characteristic data is not personally identifiable. In another embodiment, the PAN may be encrypted by a secure environment of the financial transaction processing server 106 that is separate from the activity data such that the financial transaction processing server 106 is not in possession of any personally identifiable information. The PAN of the financial transaction processing server 106 and the PAN of the demographic reporting agency 114 serve to link transaction data to demographic data, but in such a way as to prevent the possession of PII by the financial transaction processing server 106.

The characteristic data may include a plurality of characteristics. In one embodiment, the plurality of characteristics may be geo-demo characteristics, such as postal code, date of birth, age, gender, estimated income, marital status, residential status, presence of children, number of children, number in household, occupation, education, estimated home value, etc. Demographic data can include attitude date (interests, political views, etc.) that might be useful in political advertising. The specific composition of the demographic data is not particular important other than the demographic data of the reporting or tracking agency 114 and the merchant 104 needs to have overlap in the selectable characteristics. Suitable characteristics for inclusion in the plurality of characteristics will be apparent to persons having skill in the relevant art.

In step 204, the financial transaction processing server 106 may identify a subset of the characteristics. In one embodiment, the subset of characteristics may be identified such that, when applied to the received characteristic data, the result is a desired number of unique consumers. For example, a subset of characteristics may be chosen, such as postal code, birth day, birth month, birth year, gender, and estimated income, such that, when applied to the characteristic data, 70% of consumers in the characteristic data are unique with respect to the applied subset of characteristics. That is to say, 70% of consumers in the data are the only consumer with the respective combination of postal code, birth day, birth month, birth year, gender, and estimated income.

The subset of characteristics identified may depend on a number of factors and vary from application to application. For example, a merchant (e.g., the merchant 104) may request that 90% of consumers be unique, or may request specific characteristics related to its own data, as will be discussed in more detail below. The subset of characteristics identified may also be identified based on the accuracy of the characteristic. For example, estimated income may be modeled and thus not as accurate to the associated consumer as other characteristics, and also may be modeled by the demographic tracking agency 114 using a different model than that of the merchant 104, and thus result in less accurate consumer data entries 302.

In step 306, the financial transaction processing server 106 may determine if the unique population (e.g., those consumers with unique data with respect to the identified subset of characteristics) is sufficient for the specific application or project to which the data will be applied. As stated above, the sufficiency of the population may be dependent on the application or project, such as provided by the merchant 104. If the unique population is not sufficient, then the method 200 may return to step 204 and identify a new subset of characteristics.

If the unique population is determined to be sufficient, then, in step 208, the financial transaction processing server 106 may encrypt the data of the identified subset of characteristics using a one-way encryption. One-way encryption may be used such that, when combined with additional data (e.g., activity data, as discussed below) the consumer will not be personally identifiable. Suitable types and methods of one-way encryption will be apparent to persons having skill in the relevant art.

In step 210, the financial transaction processing server 106 may receive (e.g., from a server of the demographic tracking agency 114) a file including the encrypted PAN for each consumer as well as the corresponding non-encrypted PAN, but including no other potentially personally identifiable information and the PAN can be created or maintained to not be considered personally identifiable information, but rather arbitrary and/or encrypted. For instance, if a credit card number is to be used as a basis for linking transaction data to demographic data, it can be hashed or otherwise encrypted such that neither the financial transaction server 106 or the demographic tracking agency can see both types of data together with the credit card information or other PII. This might be done by the financial transaction server 106 encrypting or hashing a batch of credit card numbers and the demographic tracking agency 114 (which has both credit card numbers and demographic data for the cardholder) encrypting or hashing credit card numbers, and conveying these encrypted numbers along with select demographic data to the financial transaction server 106. The enriched data, which is devoid of PIIs, can then be used to separate or alter the anonymous card holders in to any number od demographic groups, for use as described herein.

In step 212, the financial transaction processing server 106 may combine the encrypted subset of characteristics data with the non-encrypted PAN for each corresponding consumer, based on the respective encrypted PANs. The resulting file would include encrypted characteristic data for the identified subset of characteristics and a non-encrypted PAN, such that the corresponding consumer cannot be personally identified.

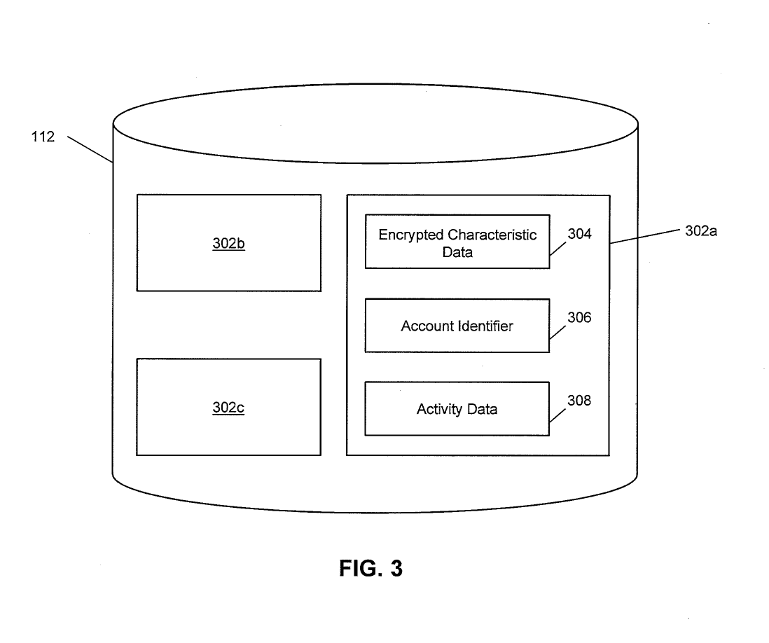

The resulting data may be stored in the encrypted data database 112, illustrated in FIG. 3. The encrypted data database 112 may include a plurality of consumer data entries 302 (e.g., consumer data entries 302a, 302b, and 302c). Each consumer data entries 402 may include at least encrypted characteristic data 304 (e.g., identified and encrypted using the method 200), an account identifier 306 (e.g., the non-encrypted PAN received in the method 200), and activity data 308.

The activity data 308 may be activity data stored in the activity data database 110. The activity data database 110 may be configured to store activity data useful for measuring the effectiveness of an advertisement, such as financial transaction data corresponding to a plurality of financial transaction associated with a consumer (e.g., the consumer 102). Other suitable types of activity data useful for performing the functions as disclosed herein will be apparent to persons having skill in the relevant art, such as behavioral data. The activity data 308 in the encrypted data database 112 would not include any personally identifiable information, as to protect the security and privacy of consumers.

Data stored in the activity data database 110 or the encrypted data database 112 of the financial transaction processing server 106, or in the characteristic data database 116 of the demographic tracking agency 114 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 118).

### Financial Transaction Processing Agency

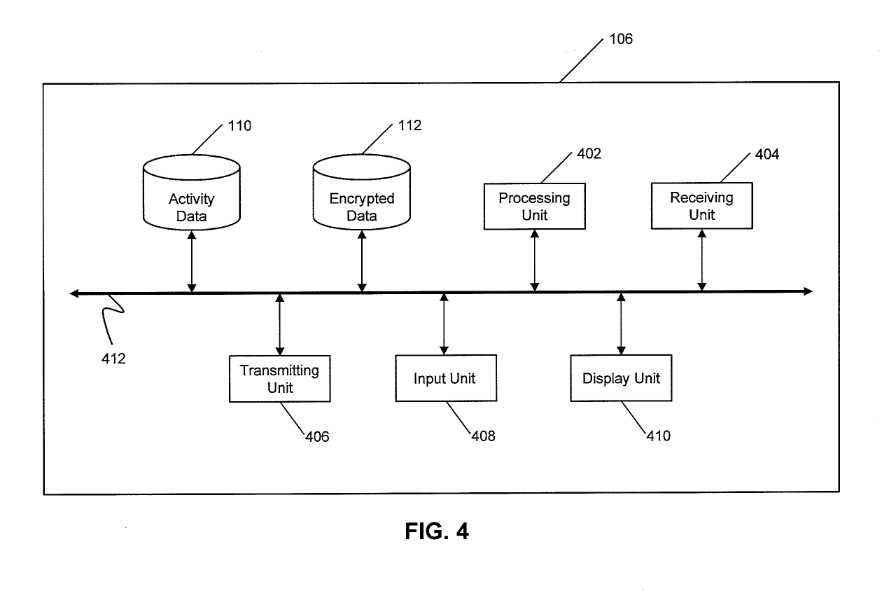

FIG. 4 is a block diagram of the financial transaction processing server 106 in the system 100.

The financial transaction processing server 106 may include the activity data database 110, the encrypted data database 112, a processing unit 402, a receiving unit 404, a transmitting unit 406, an input unit 408, and a display unit 410. Each of the components of the financial transaction processing server 106 may be configured to communicate with one another via a bus 412. Suitable types and configurations for the bus 412 will be apparent to persons having skill in the relevant art.

The receiving unit 404 may be configured to receive characteristic data, such as characteristic data transmitted by the demographic tracking agency 114 and stored in the characteristic data database 116. In an exemplary embodiment, the received characteristic data does not include any personally identifiable information. The processing unit 402 may be configured to identify, in the characteristic data, a subset of characteristics that may result in a sufficient population of unique consumers, as discussed above.

The processing unit 402 may be further configured to apply the subset of characteristics to the characteristic data, and to consider only the resulting consumers whose data of the subset of characteristics is unique to that consumer. For example, if two or more consumers share the same data for the subset of characteristics, those consumers may not be included in the populations used for measuring advertising effectiveness to provide more accurate results. The processing unit 202 may also be configured to encrypt the data of subset of characteristics using one-way encryption. Types and methods of one-way encryption suitable for performing the functions as disclosed herein will be apparent to persons having skill in the relevant art.

The transmitting unit 406 may be configured to transmit the one-way encryption used to encrypt the data. In an exemplary embodiment, the one-way encryption may be transmitted to the merchant 104). The merchant 104 may use the one-way encryption to encrypt characteristic data included in merchant data indicating consumers that are in a particular segment (e.g., exposed or not deliberately exposed to an advertisement) for which the measured effectiveness is requested. The merchant data may include a segment indicator, which may indicate a segment to which a consumer (e.g., identified by encrypted characteristic data) may belong. Types of segments useful for measuring advertising effectiveness will be apparent to persons having skill in the relevant art and may include exposure to the advertisement, no deliberate exposure to the advertisement, exposure to a first advertisement, exposure to a second advertisement, exposure to an offer, etc. The merchant data including encrypted characteristic data and segment indicators may be received by the receiving unit 404.

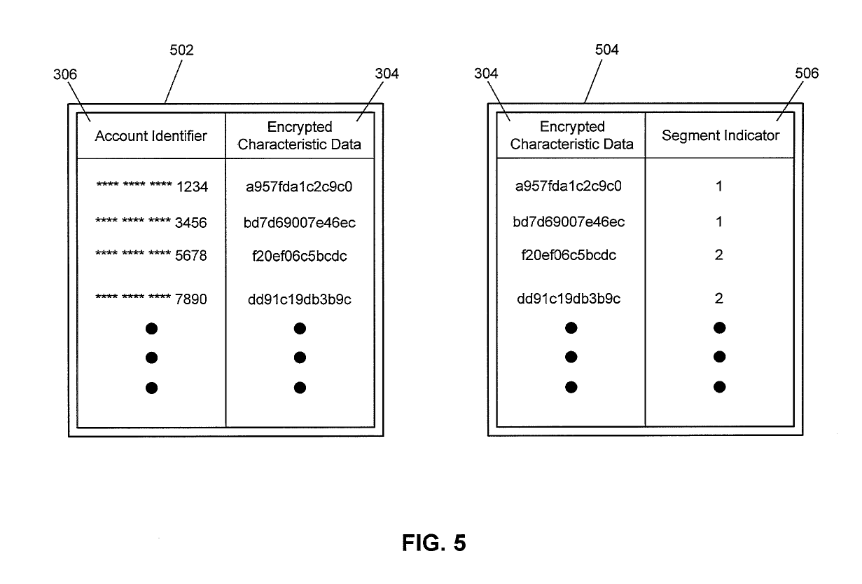

The processing unit 402 may be configured to combine the received merchant data with the data included in the encrypted data database 112 (e.g., based on the encrypted characteristic data). FIG. 5 illustrates the correspondence of the received merchant data with data included in the encrypted data database 112. Encrypted data table 502 may include data from the encrypted data database 112, such as illustrated account identifiers 306 and associated encrypted characteristic data 304 for each consumer data entry 302. Merchant data table 504 may include data from the received merchant data, such as the illustrated encrypted characteristic data 304 and associated segment indicators 506. The processing unit 402 may combine (e.g., or correspond, correlate, associate, etc.) the data included in both tables 502 and 504 such that the activity data 308 for each consumer data entry 302 can be associated with a segment indicator 506 based on the encrypted characteristic data 304.

The processing unit 202 may then analyze the activity data 308 for each consumer data entry 302 to measure the effectiveness of an advertisement based on the corresponding segment indicators 506. In one embodiment, the activity data 308 may be analyzed to determine consumer behaviors. For example, if the activity data 308 includes financial transaction data, it may be analyzed to determine amount of total spending, amount of spending at the merchant 104, amount of spending prior to and after known exposure to the advertisement, total number of transactions, number of transactions at the merchant 104, number of transactions prior to and after known exposure to the advertisement, etc. It can be seen that this is particularly effective for measuring the effectiveness of an advertising campaign for a particular merchant. Alternately or additionally, in circumstances where the transaction data includes SKU or other product identifiers, the effectiveness of advertisement for a particular product, such that a manufacture can measure the effectiveness of advertising on a product specific but merchant non-specific basis.

The effectiveness of the advertisement may then be analyzed based on consumer behaviors with respect to the corresponding segment indicator 506 and/or with respect to consumers of other/all segment indicators. For example, the increase in spending and/or transactions by the segment of consumers exposed to the advertisement compared to the spending and/or transactions of the segment of consumers not deliberately exposed to the advertisement. If the segment indicators 506 correspond to segments of consumers each exposed to a different advertisement, then the measurement may indicate which of the different advertisements is more effective. Other methods for and benefits of measuring the advertising effectiveness based on segment indicators 506 and activity data 308 will be apparent to persons having skill in the relevant art. In some embodiments, activity data corresponding to competitors of the merchant 104 may be analyzed.

The input unit 408 included in the financial transaction processing server 106 may be configured to accept input from a user. The input unit 408 may be any input device or module suitable for accepting user input for performing the functions as disclosed herein, such as a keyboard, a mouse, a capacitive touch display, etc. The input unit 408 may be used, for example, to select the subset of characteristics, to request reports on advertising effectiveness, to execute commands of the receiving unit 404, processing unit 402, or transmitting unit 406, etc. The display unit 410 may be any type of display device or display module suitable for display data to a user, such as a monitor or a touch screen display. Data displayed to the user may include the activity data 308, the measured effectiveness of an advertisement, requests for advertisement effectiveness measuring (e.g., from the merchant 104), etc.

### Method for Determining the Effectiveness of an Advertisement

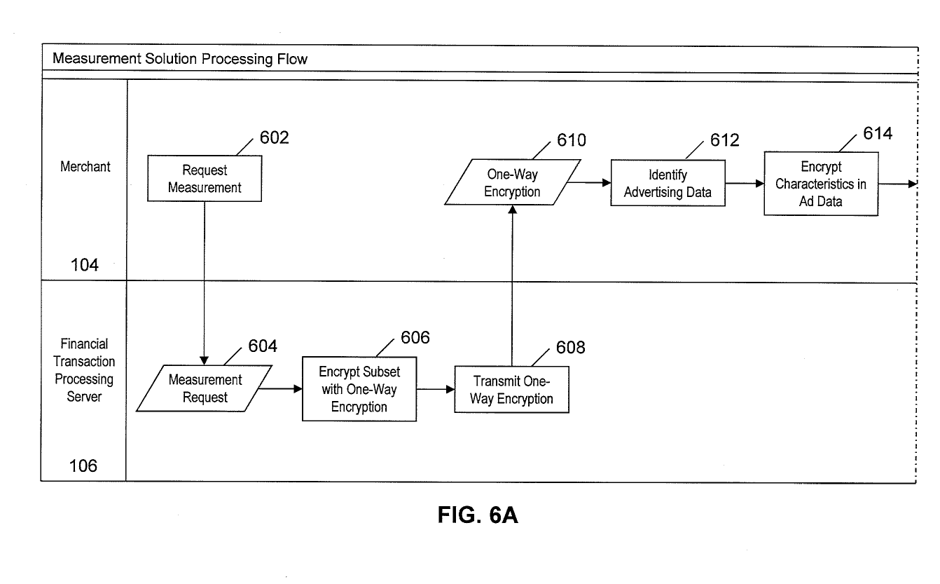

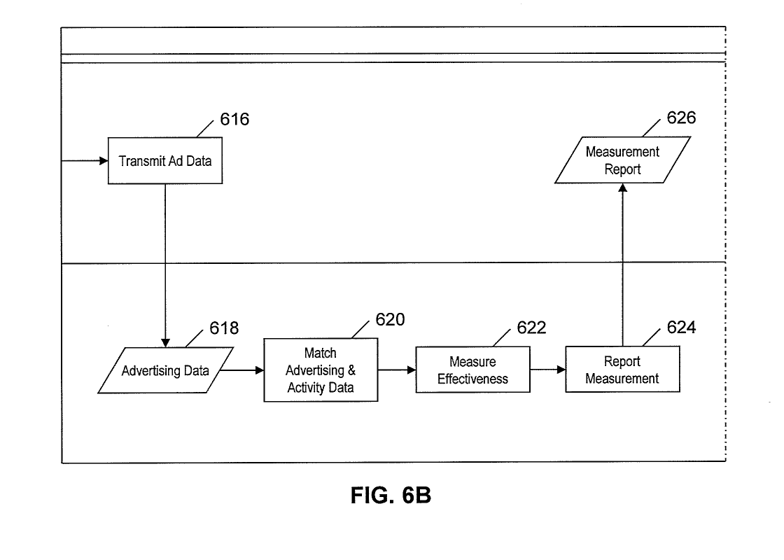

FIGS. 6A and 6B are flow diagram illustrating a measurement solution for determining the effectiveness of an advertisement using the system 100 of FIG. 1.

In step 602, the merchant 104 may request the measurement of the effectiveness of an advertisement from the financial transaction processing server 106, who may receive the request in step 604. Data included in the measurement request will be apparent to persons having skill in the relevant art and may include, for example, available characteristics for the subset of characteristics (e.g., corresponding to those available to the merchant 104 in the merchant data), desired percentage of unique consumers, type of report requested, type of measurement requested, competitors to be analyzed, etc.

In step 606, the financial transaction processing server 106 may identify a subset of characteristics in characteristic data (e.g., using the method 200 described above) and encrypt the corresponding characteristic data using a one-way encryption. In an exemplary embodiment, the characteristic data may not be personally identifiable. In one embodiment, the characteristic data may be geographic data, demographic data, or a combination thereof. In a further embodiment, the characteristic data may include a plurality of characteristics including postal code, birth day, birth month, birth year, age, gender, estimated income, marital status, residential status, presence of children, number of children, number in household, occupation, education, and estimated home value. In an even further embodiment, the identified subset of characteristics may include postal code, birth day, birth month, birth year, gender, and estimated income.

In step 608, the financial transaction processing agency 106 may transmit the one-way encryption used to encrypt the subset of characteristic data to the merchant 104, who may receive the one-way encryption in step 610. Then, in step 612, the merchant 104 may identify advertising data for which the effectiveness of the advertisement will be measured. The advertising data may include characteristic data (e.g., included at least the subset of characteristics) for consumers and corresponding segment indicators 506. In one embodiment, the segment indicators may indicate consumers exposed to and not deliberately exposed to an advertisement. In another embodiment, the segment indicators may indicate consumers exposed to a first or a second (e.g., or third, fourth, etc.) advertisement.

In step 614, the merchant 104 may encrypt the characteristic data included in the identified merchant data using the received one-way encryption, and then, in step 616, transmit it to the financial transaction processing server 106. In an exemplary embodiment, the advertising data may not include any personally identifiable information. In step 618, the financial transaction processing server 106 may receive (e.g., using the receiving unit 404) the advertising data with encrypted characteristic data 304. In step 620, the financial transaction processing server 106 may match the received advertising data with activity data 308 (e.g., and stored in the encrypted data database 112) using the encrypted characteristic data 304, such as illustrated in FIG. 5 and discussed above.

In step 622, the financial transaction processing server 106 may measure the effectiveness of the advertisement based on the segment indicators 506, as discussed in more detail above. In one embodiment, measuring the effectiveness of the advertisement may include analyzing activity data 308 corresponding to consumers. In a further embodiment, the activity data 308 may be financial transaction data. In step 624, the financial transaction processing server 106 may report the measured effectiveness to the merchant 104, who may receive the report in step 626. The measured effectiveness may be reported by any method or in any format suitable as will be apparent to persons having skill in the relevant art, such as electronic mail, in a physical report, etc.

### Exemplary Computer System Architecture

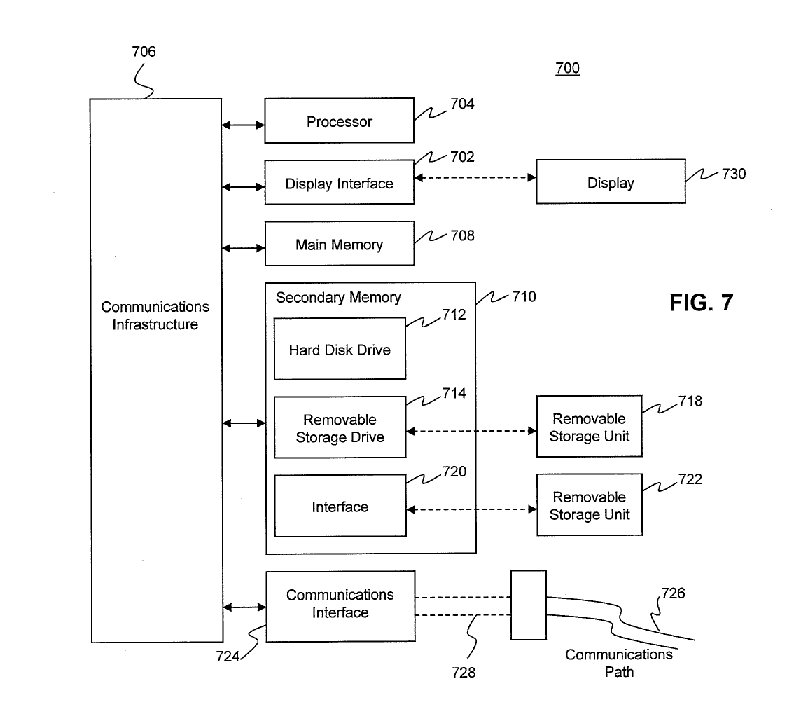

FIG. 7 illustrates a computer system 700 in which embodiments of the present disclosure, or portions thereof, may be implemented as computer-readable code. For example, the financial transaction processing server 106, demographic tracking agency 114, issuer 108, and merchant 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2, 6A, 6B, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 118), multi-core message-passing scheme, etc. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 2, 6A, 6B, and 8, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### Exemplary Method for Measuring the Effectiveness of an Advertisement

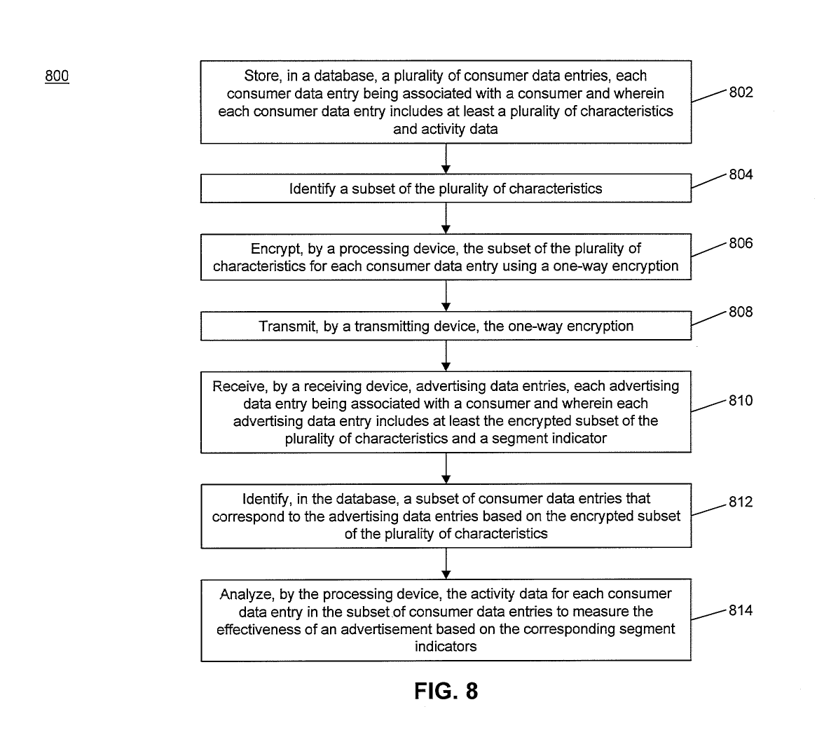

FIG. 8 illustrates an exemplary method 800 for measuring the effectiveness of an advertisement.

In step 802, a plurality of consumer data entries (e.g., consumer data entries 302) may be stored in a database (e.g., the encrypted data database 112), wherein each consumer data entry 302 may be associated with a consumer (e.g., the consumer 102) and wherein each consumer data entry 302 may include at least a plurality of characteristics and activity data (e.g., the activity data 308). In some embodiments, the activity data 308 may include financial transaction information associated with the corresponding consumer 102. In one embodiment, the plurality of characteristics may be geographical and/or demographical characteristics. In a further embodiment, the plurality of characteristics may include at least one of: postal code, birth day, birth month, birth year, age gender, estimated income, marital status, residential status, presence of children, number of children, number in household, occupation, education, and estimated home value. In an exemplary embodiment, each consumer data entry 302 does not include any personally identifiable information.

In step 804, a processor (e.g., the processing unit 402) may identify a subset of the plurality of characteristics. In one embodiment, the subset of the plurality of characteristics may include postal code, birth day, birth month, birth year, gender, and estimated income. In some embodiments, identifying the subset of the plurality of characteristics may include identifying a subset for which there is a minimum amount of consumers with unique corresponding characteristic data. In a further embodiment, the minimum amount of consumers is a number of consumers. In an alternative embodiment, the minimum amount of consumers is a percentage of total consumers.

In step 806, the processing unit 402 may encrypt the subset of the plurality of characteristics for each consumer data entry 302 using a one-way encryption. In step 808, a transmitting device (e.g., the transmitting unit 406) may transmit the one-way encryption. In one embodiment, the one-way encryption may be transmitted to a merchant (e.g., the merchant 104) requesting a measurement of the effectiveness of an advertisement.

In step 810, a receiving device (e.g., the receiving unit 404) may receive advertising data entries, each advertising data entry being associated with a consumer (e.g., the consumer 102) and wherein each advertising data entry includes at least the encrypted subset of the plurality of characteristics 304 and a segment indicator (e.g., the segment indicator 406). In one embodiment, the segment indicator 406 may indicate if the associated consumer was deliberately exposed or not exposed to the advertisement. In another embodiment, the segment indicator 406 may indicate if the associated consumer was exposed to a first advertisement or a second advertisement. In yet another embodiment, the segment indicator 406 may indicate if the associated consumer was exposed to an advertisement or an offer.

In step 812, the processing unit 402 may identify, in the encrypted data database 112, a subset of consumer data entries 302 that corresponding to the advertising data entries based on the encrypted subset of the plurality of characteristics 304. In one embodiment, identifying the subset of consumer data entries 302 may include identifying only consumer date entries 302 with a unique encrypted subset of the plurality of characteristics 304. In step 814, the processing unit 402 may analyze the activity data 308 for each consumer data entry 302 in the subset of consumer data entries 302 to measure the effectiveness of an advertisement based on the corresponding segment indicators 506. In one embodiment, analyzing the activity data 308 may include analyzing spending behaviors for each consumer data entry 302 in the subset of consumer data entries 302. In a further embodiment, the spending behaviors may include spending behaviors at a merchant (e.g., the merchant 104) associated with the advertisement. In an alternative or additional embodiment, the spending behaviors may include spending behaviors at a competitor of the merchant 104 associated with the advertisement.

Techniques consistent with the present disclosure provide, among other features, a system and method for protecting consumer privacy and security while measuring the effectiveness of an advertisement. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for measuring the effectiveness of an advertisement, comprising:
storing, in a database, a plurality of consumer data entries, each consumer data entry being associated with a consumer and wherein each consumer data entry includes at least a plurality of characteristics and activity data;
identifying a subset of the plurality of characteristics;
encrypting, by a processing device, the subset of the plurality of characteristics for each consumer data entry using a one-way encryption;
transmitting, by a transmitting device, the one-way encryption;
receiving, by a receiving device, advertising data entries, each advertising data entry being associated with a consumer and wherein each advertising data entry includes at least the encrypted subset of the plurality of characteristics and a segment indicator;
identifying, in the database, a subset of consumer data entries that correspond to the advertising data entries based on the encrypted subset of the plurality of characteristics; and
analyzing, by the processing device, the activity data for each consumer data entry in the subset of consumer data entries to measure the effectiveness of an advertisement based on the corresponding segment indicators.

2. The method of claim 1, wherein each consumer data entry does not include any personally identifiable information.

3. The method of claim 1, wherein the plurality of characteristics are geographical and/or demographic characteristics.

4. The method of claim 3, wherein the plurality of characteristics includes at least one of: postal code, date of birth, age, gender, estimated income, marital status, residential status, presence of children, number of children, number in household, occupation, education, and estimated home value.

5. The method of claim 1, wherein the activity data includes financial transaction information associated with the corresponding consumer.

6. The method of claim 1, wherein the subset of the plurality of characteristics includes postal code, birth day, birth month, birth year, gender, and estimated income.

7. The method of claim 1, wherein the segment indicator indicates if the associated consumer was deliberately exposed or not exposed to the advertisement.

8. The method of claim 1, wherein identifying the subset of consumer data entries includes identifying only consumer data entries with a unique encrypted subset of the plurality of characteristics.

9. The method of claim 1, wherein analyzing the activity data includes analyzing spending behaviors for each consumer data entry in the subset of consumer data entries.

10. The method of claim 9, wherein spending behaviors includes spending behaviors at a merchant associated with the advertisement.

11. The method of claim 9, wherein spending behaviors includes spending behaviors at a competitor of a merchant associated with the advertisement.

12. The method of claim 1, wherein identifying a subset of the plurality of characteristics includes identifying a subset of the plurality of characteristics for which there is a minimum amount of consumers with unique corresponding characteristics data.

13. The method of claim 12, wherein the minimum amount of consumers is a percentage of total consumers.

14. A system for measuring the effectiveness of an advertisement, comprising:
a database configured to store a plurality of consumer data entries, each consumer data entry being associated with a consumer and wherein each consumer data entry includes at least a plurality of characteristics and activity data;
a processor configured to
identify a subset of the plurality of characteristics,
encrypt, using a one-way encryption, the subset of the plurality of characteristics for each consumer data entry, and
transmit the one-way encryption; and
a receiver configured to receive advertising data entries, each advertising data entry being associated with a consumer and wherein each advertising data entry includes at least the encrypted subset of the plurality of characteristics and a segment indicator,
wherein the processor is further configured to
identify, in the database, a subset of consumer data entries that correspond to the advertising data entries based on the encrypted subset of the plurality of characteristics, and
analyze the activity data for each consumer data entry in the subset of consumer data entries to measure the effectiveness of an advertisement based on the corresponding segment indicators.

15. The system of claim 14, wherein each consumer data entry does not include any personally identifiable information.

16. The system of claim 14, wherein the plurality of characteristics are geographical and/or demographic characteristics.

17. The system of claim 16, wherein the plurality of characteristics includes at least one of: postal code, date of birth, age, gender, estimated income, marital status, residential status, presence of children, number of children, number in household, occupation, education, and estimated home value.

18. The system of claim 14, wherein the activity data includes financial transaction information associated with the corresponding consumer.

19. The system of claim 14, wherein the subset of the plurality of characteristics includes postal code, birth day, birth month, birth year, gender, and estimated income.

20. The system of claim 14, wherein the segment indicator indicates if the associated consumer was deliberately exposed or not exposed to the advertisement.

21. The system of claim 14, wherein identifying the subset of consumer data entries includes identifying only consumer data entries with a unique encrypted subset of the plurality of characteristics.

22. The system of claim 14, wherein analyzing the activity data includes analyzing spending behaviors for each consumer data entry in the subset of consumer data entries.

23. The system of claim 22, wherein spending behaviors includes spending behaviors at a merchant associated with the advertisement.

24. The system of claim 22, wherein spending behaviors includes spending behaviors at a competitor of a merchant associated with the advertisement.

25. The system of claim 22, wherein identifying a subset of the plurality of characteristics includes identifying a subset of the plurality of characteristics for which there is a minimum amount of consumers with unique corresponding characteristics data.

26. The method of claim 12, wherein the minimum amount of consumers is a percentage of total consumers.
